(19) United States
(12) Patent Application Publication
(10) Pub. No.: US 2008/0086771 A1
(43) Pub. Date: Apr. 10, 2008

(54) APPARATUS, SYSTEM, AND METHOD FOR AUTHENTICATING USERS OF DIGITAL COMMUNICATION DEVICES

(76) Inventors: Kang Li, Watkinsville, GA (US); Andrew Maliszewski, Lawrenceville, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/867,355

(22) Filed: Oct. 4, 2007

Related U.S. Application Data
(60) Provisional application No. 60/828,148, filed on Oct. 4, 2006.

(51) Int. Cl. H04L 9/32

(52) U.S. Cl. 726/20; 726/2

(57) ABSTRACT

A computer authentication device comprising a memory containing a long secret or digital signature, portions of which are requested by a server computer or other device. The authentication device evaluates the nature and timing of authentication requests and selectively varies the time delay for responding to such authentication requests. Such selective variation in response times impedes the unauthorized or malicious copying of the authentication device's authentication credentials.

### CROSS-REFERENCE TO RELATED APPLICATIONS

This application claims priority to U.S. provisional application No. 60/828,148, filed Oct. 4, 2006, which is incorporated herein by reference.

### BACKGROUND OF THE INVENTION

The invention relates to an apparatus, system, and method for authenticating a computer user to a server or network.

Authentication mechanisms are very important to provide secure communications in an inherently insecure computing environment. Authentication is a process by which computers can verify the identity of other computers or computer users with which they communicate. This is necessary to ensure that no malicious person or software is impersonating the actions of another in an attempt to gain access to sensitive data, computer networks, or other secure systems.

Currently, most authentication mechanisms utilize a password-based system whereby the user enters a password that is then verified against the copy of the password stored at the server. This type of authentication process is susceptible to a variety of attacks. Passwords are often written down and can be copied by others. They can be intercepted by malicious software (computer viruses or malware) present on a person's computer. Such viruses can include keylogging software that records the letters that are typed on a user's computer keyboard and forwards them to an unauthorized person or computer system. Users are especially vulnerable to such software when they use a public computer (at a hotel or airport, e.g.) or indeed any unfamiliar computer. Because the computer user has no control over the maintenance of any such computer, the user cannot be sure that the computer is secure and free of computer viruses or that the computer uses secure communications protocols such as Secure Sockets Layer (“SSL”).

Computer users are also susceptible to phishing attacks whereby the user is tricked into thinking that a particular web site or computer system is genuine when in fact the web site or system is merely impersonating the genuine site. This often happens when a user receives an unsolicited email from an imposter posing as a known business partner. Recognizing the business partner, the user may click the enclosed hyperlink and voluntarily enter his or her password into the counterfeit site, thus compromising the security of his or her password. Phishing attacks can also occur when a user makes a spelling mistake while typing a Uniform Resource Locator (“URL”) into a web browser and is taken to a counterfeit web site.

Passwords are often also inherently insecure because they are usually chosen by a user and the user may select a password that can be easily guessed. For example, the user might use a simple English word (or a word in any human language). Malicious persons can compromise the computer system by exhaustively trying all words in the dictionary. In addition, human-chosen passwords are often insecure because the user will utilize commonly known information (such as his or her name, birthday, or a family member's name or birthday). This information is often known by various people familiar with the user. Also, much of this data can be obtained from public databases such as marriage records, birth records, driver's license information, or tax records.

Finally, human-chosen passwords are inherently insecure because people generally do not change their passwords very often. Therefore, once an unauthorized individual has obtained a user's password, that individual can repeatedly access the user's private data. Moreover, even when users do change their passwords, they often re-use an old password or simply increment a number on the end of their current password. Thus, once a malicious individual has obtained a user's password, it is often simple for that individual to guess any changes to that password.

An alternative to password-based authentication is an “ownership authentication” system whereby a user or client computer is authenticated to a remote server by presenting a unique token that is possessed or “owned” by the authenticating user or client computer. One common such token is the biometric data of a particular user (such as his or her fingerprints, iris pattern, or voice print information). Another such token is a device that contains a digital signature—in essence, a password, a series of passwords, or an algorithm for generating a series of passwords is placed on the device by the manufacturer.

Such tokens present certain problems, however. For personal privacy reasons, people are often uncomfortable using biometric tokens because they do not wish to have their fingerprints or other biometric data stored on a computer and accessed on a routine basis. Some people also fear that a determined would-be hacker might physically harm them in order to obtain their biometric data. In addition, computers need specialized equipment such as fingerprint or iris readers to authenticate using biometric data. Finally, biometric data is immutable and does not change; thus, once copied, an unauthorized user can continue using a person's biometric data forever.

Token devices that contain a password or digital signature can also be compromised. If the token device is connected to a computer, it can be copied by unauthorized or malicious software that is resident on that computer. This can occur, for example, if the user's computer is infected with a computer virus or other malware. It can also occur if the user utilizes his or her token device on a public computer or any other unfamiliar computer if that computer contains malicious software or if it uses insecure communication channels.

Some token devices are less susceptible to being copied because they do not directly connect to a computer. Rather, the user reads a string of characters (a password) off of the device's display and physically enters the characters on a computer keyboard or other input device, often within a short time limit such as one minute. Such a system has the disadvantage that the user must manually enter the string of characters into the computer each time he or she wishes to authenticate. This can sometimes be a cumbersome and frustrating process, especially if the user is a slow typist and the password changes rapidly on the token device. If the token device's password changes slowly or contains a static password, however, then there is an increased danger that an unauthorized user could replicate the password and gain access to the secured system. Finally, this system requires human interaction to enter the password on the input device. Thus, it is not suitable for situations where the user desires to insert the token device into a computer where it can be periodically interrogated over a length of time to periodically re-authenticate the client computer to the server.

### SUMMARY OF THE INVENTION

In an embodiment of the present invention, the user possesses a token device which contains a large “long secret”. This long secret is a large piece of data which is unique to the user's particular token device and is utilized to authenticate the user to the server computer. When the user wishes to authenticate, he or she must connect the token device to the client computer through an input device (such as a Universal Serial Bus [“USB”] port, Bluetooth connection, or some other input device). The server—which contains an identical copy of the user's long secret—periodically interrogates the client computer for a very small portion (the “interrogation address range”) of the long secret.

The user's token device in an embodiment of the present invention contains software or hardware that is capable of evaluating the nature and timing of the server's interrogations. Specifically, the token device will only respond to the server after exponentially increasing time delays if the server interrogates the token device too frequently. For instance, if the server improperly interrogated the token device five times in 10 seconds, the token device in one embodiment of the invention would only respond to the first interrogation and would exponentially increase the time delay that it required before it would respond to any subsequent interrogation.

Similarly, the token device in an embodiment of the present invention will respond to the server only after an exponentially increasing time delay if the server's interrogation is for an improper length or section of the long secret. Thus, if the server improperly requested 16 bytes when it was supposed to request 12 bytes, the user's token device would refuse to authenticate and would only evaluate new interrogations after an exponentially increased time delay between interrogations.

The token device in an embodiment of the present invention will thus not allow its long secret to be repeatedly interrogated by any server—either legitimate or malicious—in a short period of time. This “communication dampening”—whereby the token device provides quick responses to server interrogations that are sparse over time but slow responses to server interrogations that occur rapidly in succession—prevents malicious individuals or software from duplicating the token device's long secret in a short period of time. By adjusting the length of time between acceptable device interrogations, the time delay following improper device interrogations, the length and starting point of the interrogation address range, and the total length of the long secret, the present invention minimizes the chances that an unauthorized individual will be able to replicate the user's long secret. Indeed, with the proper configuration, the total amount of authorized interrogations of the token device can be held to a negligible percentage of the total length of the long secret, thus rendering it difficult for an unauthorized user to utilize even a portion of the long secret to impersonate the legitimate user.

The token device in another embodiment of the present invention utilizes an algorithm in lieu of the long secret. In effect, the algorithm creates a “virtual” long secret that need not be stored in memory, but rather can be generated as needed through computation. This algorithm allows the token device to generate appropriate responses to server interrogations without having a large memory to store the long secret. In addition, the server can use less memory since it need not store the long secret.

In another embodiment of the present invention, the token device utilizes a hybrid approach where an algorithm is used in conjunction with a long secret to generate the appropriate responses to server interrogations. In this embodiment, the token device must store the long secret in memory, but the long secret can be shorter than in embodiments where no algorithm is used to aid in the generation of the interrogation responses.

### BRIEF DESCRIPTION OF THE DRAWINGS

FIG. 1 is a block diagram of an authentication system in an embodiment of the present invention.

FIG. 2 is a block diagram containing a logical view of a token authentication device in an embodiment of the present invention.

FIG. 3 is a flow chart of an exemplary method of authenticating a client computer to a server computer in an embodiment of the present invention.

### DETAILED DESCRIPTION

In an exemplary embodiment, the present invention includes a server computer that remotely authenticates a user's token authentication device that is connected to a client computer. It will be appreciated that “server computer” and “client computer” can include a broad variety of devices including, but not limited to, desktop computers, laptop computers, web sites, personal digital assistants (“PDAs”), mobile devices, routers, telephones, televisions, and the like. In addition, a “server computer” or “client computer” could be implemented in software, hardware, or in a combination of software and hardware. It will be further appreciated that a given computer or device can act both as a “server” and as a “client”. Thus, a given computer can both interrogate other computers and respond to interrogations from other computers. Finally, it will be appreciated that the token authentication device of the present invention could be “connected” to a client computer via wired or wireless communication.

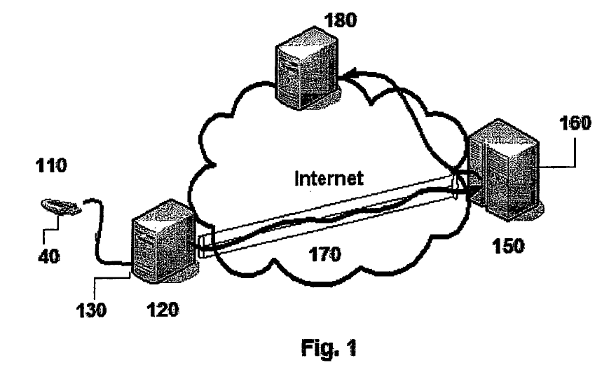

In FIG. 1, a token authentication device 110 in one embodiment of the invention connects to a client computer 120 through a Universal Serial Bus (“USB”) port 130. It will be appreciated by those skilled in the art that the token authentication device 110 could communicate with the client computer 120 utilizing a variety of methods including, but not limited to, Bluetooth communication, WiFi communication, Radio Frequency (“RF”) communication, Ethernet cables, serial cables, smart cards, hard drives, discs, diskettes, and the like. It will be further recognized that the token authentication device 110 could be an integral part of the client computer 120. The token authentication device 110 contains a digital long secret 140, portions of which are used to authenticate the token authentication device 110 to a server computer 150.

A server computer 150 in one embodiment of the invention contains a server copy of the long secret 160 which is identical to the copy of the long secret 140 stored on the token authentication device 110. The server computer 150 periodically and selectively interrogates the client computer 120 for a portion of the long secret. The client computer 120, in turn, interrogates the token authentication device 110 for the same portion of the long secret. As described in more detail below, the token authentication device 110 in certain situations will respond to the server interrogation only after a selectively varying time delay. This time delay will prevent an unauthorized server computer or other device from rapidly copying the long secret 140 stored on the token authentication device 110.

Those skilled in the art will recognize that an algorithm could be used to generate a “virtual” long secret instead of—or in addition to—storing the long secret 140 in memory on the token authentication device 110. An identical algorithm could be used to generate the identical “virtual” long secret on the server computer 150 instead of—or in addition to—storing the long secret 160 in memory on the server computer 150. Such an algorithm could lower the memory requirements of the token authentication device 110 and the server computer 150. Examples of such algorithms by way of illustration, but not limitation, include any of the strong one-way hash functions such as SHA-1 or MD5.

Those skilled in the art will further recognize that the long secret—or the algorithm utilized to generate the “virtual” long secret—could be periodically changed in order to enhance the security of the present invention. Periodically changing the long secret would render useless any previous unauthorized copying of the old long secret or algorithm since the new long secret or algorithm would be used for all future authentications.

In one embodiment, all communications between the client computer 120 and the server computer 150 are conducted over a secure network 170 using Secure Sockets Layer (“SSL”). Those skilled in the art will recognize that such communications can utilize other security protocols and/or be conducted over private dedicated networks.

After authenticating the user's token authentication device 110, the server computer 150 in one embodiment will function as a proxy server, routing messages between the client computer and any number of desired third-party destination servers 180. Such communications can similarly be conducted using SSL or other security protocols and be over public networks or private networks. The server computer 150 may periodically re-authenticate the token authentication device 110 by interrogating the client computer 120 for another portion of the long secret 140 stored in the user's attached token authentication device 110.

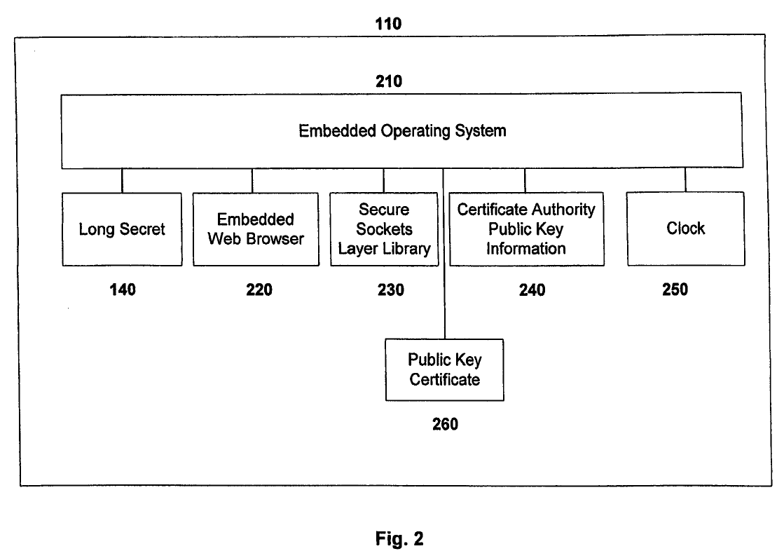

FIG. 2 shows a logical view of a token authentication device in an embodiment of the present invention. The token authentication device 110 contains a long secret 140, a copy 160 of which is located on the server computer 150. The token authentication device 110 also includes a write-protected memory region which contains an embedded operating system 210. Those skilled in the art will recognize that the embedded operating system 210 can be implemented using several modules or libraries and need not be a unitary file or address space. The embedded operating system 210 can also be implemented using hardware or some combination of hardware and software.

The embedded operating system 210 controls access to the long secret 140 and will not allow remote computers to read the long secret 140 directly. This prevents malicious users or software from copying the entire long secret 140 in a single device interrogation. The embedded operating system 210 will furthermore not permit remote computers to modify it or overwrite it. This prevents malicious users or software from gaining control over the token authentication device 110.

The token authentication device 110 includes an internal clock 250 that is controlled by the embedded operating system 210. The embedded operating system 210 will not permit remote computers or devices to modify or control the internal clock 250. The token authentication device 110 can utilize the internal clock 250 to count the elapsed time between interrogations from the server computer 150 without the risk that the internal clock 250 has been manipulated or tampered with by malicious computers or software. As explained in more detail below, the elapsed time between interrogations can be used to prevent copying of the authentication device's 110 long secret 140.

In one embodiment of the present invention, the token authentication device 110 includes a write-protected memory region which contains an embedded web browser 220. Users desiring to access the internet can thus utilize the portable and secure web browser 220 that is embedded in the token authentication device 110, rather than relying on possibly insecure web browser software on a client computer 120. The embedded operating system 210 controls access to the embedded web browser 220 and prevents remote computers from modifying it.

The token authentication device 110 contains, in one embodiment, a Secure Sockets Layer library 230 that is stored in a write-protected memory region. The embedded operating system 210 controls access to the embedded SSL library 230 and prevents remote computers from modifying it.

In one embodiment, the token authentication device 110 contains public key information 240 relating to trusted certificate authorities (“CAs”) such as VeriSign, Inc. The embedded operating system 210 controls access to the embedded certificate authority public key information 240 and prevents remote computers from modifying it.

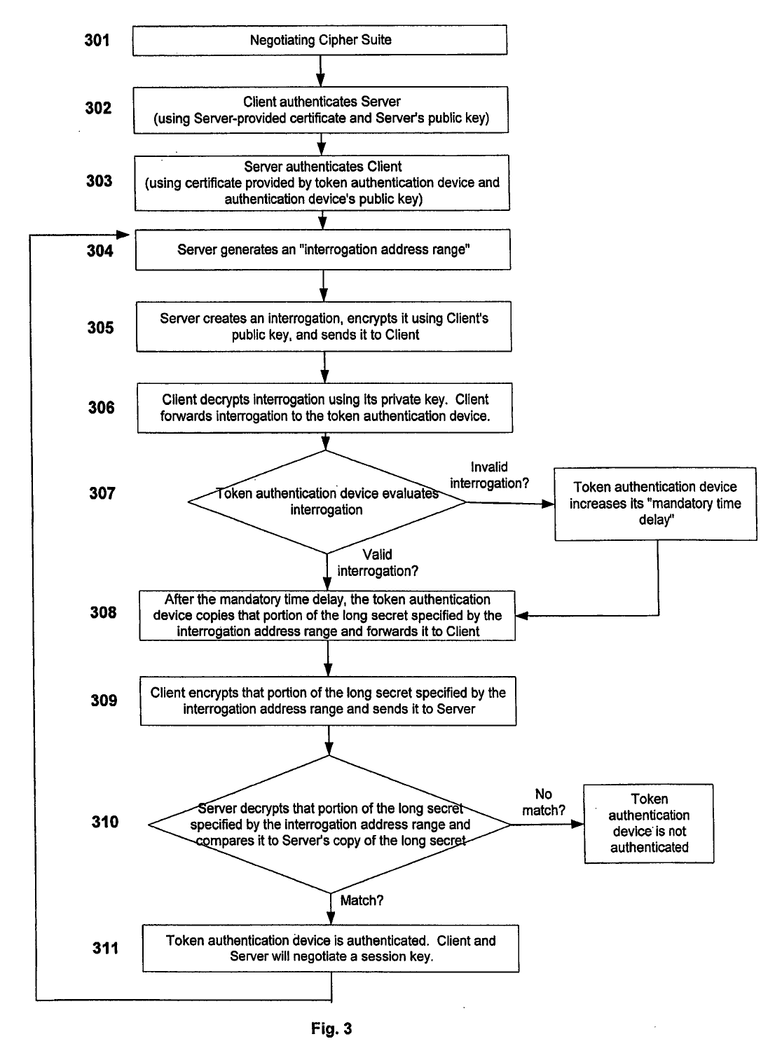

FIG. 3 depicts the steps utilized to authenticate a user's token authentication device 110 in one embodiment of the present invention. At step 301, the client computer 120 loads the SSL library 230 from the write-protected memory region of the token authentication device 110. The client computer 120, using the SSL library 230 it has loaded into memory, communicates with the server computer 150 and negotiates a cipher suite that is supported by both sides.

In step 302, the client computer 120 authenticates the server computer 150 based on the certificate delivered from the server computer 150 and the public key certificate authority data 240 stored on the token authentication device 110.

At step 303, the server computer 150 authenticates the client computer 120 based on the certificate 260 delivered from the token authentication device 110 and the public key certificate authority data stored on the server computer 150.

At step 304, the server computer 150 generates an address range indicating which portion of the long secret it will use to authenticate the token authentication device 110. This “interrogation address range” is of a fixed length in some embodiments. In other embodiments, the length of the interrogation address range can vary from one interrogation to another. The length of the interrogation address range is small, however, in relation to the total length of the long secret 160.

In some embodiments, such variation in interrogation address range lengths is random or pseudo-random while in other embodiments, such variation is based on a pre-determined algorithm. In yet other embodiments, such variation is pre-determined and maintained as a list.

In embodiments where the interrogation length varies based on a pre-determined algorithm or list, the token authentication device 110 can contain the identical algorithm or list in its write-protected memory. This will allow the embedded operating system 210 of the token authentication device 110 to verify that a given interrogation address range is of the proper length.

The interrogation address range that is selected by the server computer 150 can also vary as to its starting point within the long secret. In some embodiments, rather than requesting serial portions of the long secret, the server computer 150 will vary the starting point of the address range of its interrogations. In some embodiments, this variation in the starting point of the interrogation address range is random or pseudo-random while in other embodiments, such variation is based on a pre-determined algorithm. In yet other embodiments, such variation is pre-determined and maintained as a list.

In embodiments where the starting point of the interrogation address range varies based on a pre-determined algorithm or list, the token authentication device 110 can contain the identical algorithm or list in its write-protected memory. This will allow the embedded operating system 210 of the token authentication device 110 to verify that a given interrogation address range starts at the proper location.

Those skilled in the art will recognize that a given interrogation address range need not be in a contiguous address range. For example, one interrogation might request sixteen non-contiguous bytes, each byte specified in a separate address range. Alternatively, an interrogation could request sixteen bytes divided into three address ranges of ten, four, and two bytes respectively.

At step 305, the server computer 150 packages the interrogation address range calculated in step 304 into an interrogation. The server computer 150 then encrypts the interrogation with the client computer's 120 public key and sends it to the client computer 120.

At step 306, the client computer 120 receives the interrogation and decrypts the interrogation using its private key. The client computer 120 then forwards the interrogation to the token authentication device 110.

At step 307, the embedded operating system 210 of the token authentication device 110 evaluates the interrogation to determine if it is valid or invalid. For instance, in one embodiment, an authentication device 110 that receives an interrogation within 100 seconds of a prior interrogation will regard the subsequent interrogation as invalid. The authentication device 110 can utilize its secure internal clock 250 to count the elapsed seconds and not rely on an insecure external clock that could be artificially sped up by a malicious individual seeking to copy the device's long secret. In some embodiments, if the length or starting point of the interrogation address range is incorrect based on the pre-existing algorithm or list stored on the token authentication device 110, then the interrogation is invalid.

In some embodiments of the invention, the token authentication device 110 will react to an invalid interrogation by increasing the “mandatory time delay” that the authentication device will wait before responding to interrogations. In some embodiments, the token authentication device 110 will not respond to an invalid interrogation. In some embodiments, repeated invalid interrogations will cause the token authentication device 110 to exponentially increase the “mandatory time delay” required before responding to interrogations. Such increases in required time delays will prevent malicious users from copying the long secret from the authentication device 110 through repeated interrogations over a short period of time.

For instance, in one embodiment, the token authentication device 110 has a base “mandatory time delay” of zero seconds, an “interrogation window” of 100 seconds, and a “reset time” of 5000 seconds. The “mandatory time delay” is the amount of time that the token authentication device 110 will wait to respond to an interrogation. The “interrogation window” is the minimum amount of time needed between interrogations to prevent the token authentication device 110 from increasing the “mandatory time delay”. The “reset time” is the time required following an interrogation before the authentication device 110 will reset its “mandatory time delay” to its base value.

Thus, when in its base state, the token authentication device 110 in this embodiment will respond immediately (i.e., after zero seconds) to an interrogation. However, for every x interrogations received before 100 seconds have elapsed since the prior interrogation, the authentication device 110 will increase the “mandatory time delay” by eight seconds raised to the power of x. Thus, if the authentication device 110 receives five interrogations in quick succession, it will respond immediately to the first interrogation. The remaining four interrogations come within successive “interrogation windows”, however, and will cause the authentication device 110 to increase its “mandatory time delay”. The fourth invalid interrogation will cause the authentication device 110 to increase the “mandatory time delay” by eight raised to the fourth power, or 4096, seconds (approx. 68 minutes).

In some embodiments, the “mandatory time delay” will not increase beyond an upper bound. In some embodiments, the “interrogation window” will increase along with the “mandatory time delay”. In some embodiments, the base “mandatory time delay” is set to a time period greater than zero. Those skilled in the art will recognize that various algorithms exist to exponentially, arithmetically, or otherwise selectively vary the “mandatory time delay” after receiving an invalid interrogation. Similarly, those skilled in the art will recognize various algorithms to reset the “mandatory time delay” to an initial value or to some other low value. These algorithms can also be used to modify the “interrogation window”.

At step 308, the token authentication device 110, after waiting the appropriate amount of time corresponding to the “mandatory time delay”, will respond to an interrogation by communicating that portion of the long secret specified by the interrogation address range to the client computer 120 in a message. In some embodiments, the token authentication device 110 will only respond to valid interrogations and will not respond to invalid interrogations.

At step 309, the client computer 120 will encrypt the message that it received from the token authentication device 110 using the server computer's 150 public key. The client computer 120 will then send the encrypted message to the server computer 150.

At step 310, the server computer 150 will receive the message and decrypt it using its private key. It will compare the contents of the message with the specified interrogation address range of its copy of the long secret 160. If the message matches the server computer's copy, then the server computer 150 will deem the token authentication device 110 to have properly authenticated itself.

At step 311, if the token authentication device 110 is properly authenticated, the server computer 150 and client computer 120 will proceed to generate a symmetric session key that will be used for further communication during the session. The server computer may periodically re-authenticate the token authentication device 110, following steps 304-311. The server computer 150 must wait longer than the “interrogation window” after each authentication, however, to avoid generating an invalid interrogation and causing the “mandatory time delay” to increase.

Example of Implementation

In one non-limiting exemplary embodiment, the long secret embedded in the token authentication device is 128 MB long. An identical copy of the long secret is stored on the server computer. The length of each server interrogation (the interrogation address range) is 16 bytes. Thus, each interrogation is for only 0.0000119% of the total length of the long secret: 16 bytes/128 MB=16/(1028*1024̂2)=0.0000119%.

The token authentication device will have an initial “mandatory time delay” of zero seconds (i.e., no delay). It will have an initial “interrogation window” of 100 seconds. Thus, any server interrogation will be invalid if it follows the previous interrogation by less than 100 seconds. For every n-th invalid interrogation, the authentication device will increase the “mandatory time delay” by 8 seconds raised to the n-th power. The “interrogation window” will never be less than the “mandatory time delay” in this embodiment.

In this embodiment, the authentication device will not respond to invalid interrogations. Rather, the device will merely increase the “mandatory time delay”. Also, this embodiment has a “reset time” of 5000 seconds.

The following table illustrates the increase in the “mandatory time delay” where one valid interrogation is followed rapidly by four invalid interrogations:

| | | Mandatory | Mandatory |
|---|---|---|---|
| Invalid | Increase in Mandatory | time delay | time delay |
| interrogation no. | Time Delay [seconds] | [seconds] | [minutes] |
| <base> | <none> | 0 | 0 |
| 1 | 8 | 8 | 0.133 |
| 2 | 64 | 72 | 1.200 |
| 3 | 512 | 584 | 9.733 |
| 4 | 4096 | 4680 | 78 |

As can be observed, multiple invalid interrogations in quick succession cause the token authentication device to rapidly increase the “mandatory time delay” that it will wait to respond to valid interrogations. After the fourth invalid interrogation, the “mandatory time delay” has been increased to 4680 seconds, or 78 minutes.

This rapid increase in the “mandatory time delay” will prevent a malicious individual or software program from rapidly reading the entire long secret. Indeed, in this exemplary embodiment, a malicious client who attempted to interrogate the authentication device every second would only succeed on the first interrogation and would fail thereafter. Thus, as illustrated above, such a malicious client would succeed in copying only 0.0000119% of the long secret.

In this exemplary embodiment, the “mandatory time delay” and “interrogation window” of the token authentication device have an upper limit of 4680 seconds. Thus, the “mandatory time delay” and “interrogation window” will not increase if a fifth or subsequent invalid interrogation is received. After the authentication device has been free of interrogations for the requisite “interrogation window”, then the device will be ready to accept new valid interrogations.

In this exemplary embodiment, the token authentication device will also reset the “mandatory time delay” and “interrogation window” to their base values of zero seconds and 100 seconds, respectively, after 5000 seconds have elapsed since the last interrogation. This “reset time” of 5000 seconds will allow the device to return to its normal base state after having received multiple invalid interrogations (which resulted in elevated “mandatory time delay” and “interrogation window” values.)

Those skilled in the art will recognize that the “mandatory time delay” value could be changed in a variety of manners. For instance, the time delay could increase arithmetically rather than exponentially. It could increase based on other factors such as whether the authentication device was being used on a public computer or a trusted computer.

Those skilled in the art will also recognize that the value for the base “mandatory time delay” and the base value for the exponential increases in the “mandatory time delay” could vary. For instance, the base “mandatory time delay” could be set to 100 seconds to match the base “interrogation window”. The base value for the exponential increases in the “mandatory time delay” could be set to any number greater than one. Lower values for the base “mandatory time delay” and/or the base value for the exponential increases in the “mandatory time delay” will allow more interrogations in quick succession before the authentication device reaches a state where the “mandatory time delay” is large:

Accordingly, while the invention has been described with reference to the structures and processes disclosed, it is not confined to the details set forth, but is intended to cover such modifications or changes as may fall within the scope of the following claims.

What is claimed is:

1. A computer authentication apparatus for use with a computer comprising:
at least one input device capable of communicating with said computer;
at least one output device capable of communicating with said computer;
at least one memory;
said memory containing at least one large long secret;
at least one control unit;
said control unit capable of receiving a plurality of interrogations from said computer via said input device;
said control unit capable of transmitting a plurality of small portions of said long secret from said memory to said computer via said output device;
wherein said transmissions to said computer occur with varying time delays between said transmissions; and
wherein only one of said plurality of small portions of said long secret is transmitted during any one transmission.

2. The apparatus of claim 1 wherein said control unit is an executable program stored in said memory.

3. The apparatus of claim 1 wherein said control unit is a processor capable of executing an executable program stored in said memory.

4. The apparatus of claim 1 wherein the time delays between the transmissions by said control unit to said computer increase until an upper limit is reached.

5. The apparatus of claim 1 wherein the time delays between the transmissions by said control unit to said computer vary in a pre-determined manner.

6. The apparatus of claim 1 wherein the time delays between the transmissions by said control unit to said computer vary in a random manner.

7. The apparatus of claim 1 wherein each one of said plurality of small portions of said long secret vary in length in a pre-determined manner.

8. The apparatus of claim 1 wherein each one of said plurality of small portions of said long secret vary in length in a random manner.

9. The apparatus of claim 1 wherein said long secret is created in whole or in part utilizing an algorithm.

10. The apparatus of claim 1 wherein said long secret is periodically changed.

11. The apparatus of claim 1 further comprising at least one internal clock.

12. A method for authenticating an authentication device to a server wherein the authentication device and server each contain an identical copy of a long secret comprising the steps of:
a. interrogating the authentication device for a specified portion of the long secret to be transmitted from the authentication device to the server;
b. evaluating said interrogation for its validity;
c. transmitting said specified portion of the long secret from the authentication device to the server after a specified time delay;
d. verifying at the server that said authentication device transmission of said specified portion of the long secret matches said specified portion of the long secret thereby authenticating said authentication device to server; and
e. periodically repeating steps a through d.

13. The method of claim 12 wherein said evaluation of said interrogation for its validity involves determining whether said interrogation falls within a pre-determined interrogation window.

14. The method of claim 13 wherein said time delay is increased if said interrogation is invalid.

15. The method of claim 14 wherein said time delay increases until an upper limit is reached.

16. The method of claim 14 wherein said time delay varies in a pre-determined manner.

17. The method of claim 14 wherein said time delay varies in a random manner.

18. The method of claim 14 wherein the server's interrogations of said specified portions of said long secret vary in length in a pre-determined manner.

19. The method of claim 14 wherein the server's interrogations of said specified portions of said long secret vary in length in a random manner.

20. The method of claim 14 wherein said long secret is created in whole or in part utilizing an algorithm.

21. The method of claim 14 wherein said long secret is periodically changed.

22. The method of claim 14 wherein said time delay generated at said authentication device is generated utilizing at least one clock internal to said authentication device.

23. A system for authenticating an authentication device on a computer network wherein said network comprises at least a server and said authentication device comprising:
said authentication device containing at least one memory;
said memory containing at least one large long secret;
said authentication device containing at least one control unit;
said control unit capable of receiving a plurality of interrogations from said server;
said control unit capable of transmitting a plurality of small portions of said long secret from said memory to said server;
wherein said transmissions to said server occur with selectively varying time delays between said transmissions; and
wherein only one of said plurality of small portions of said long secret is transmitted during any one transmission.

24. The system of claim 23 wherein said selectively varying time delays increase if one of said plurality of interrogations from said server is received at said control unit of said authentication device within a pre-determined interrogation window.

25. The system of claim 24 wherein said control unit is an executable program stored in said memory.

26. The system of claim 24 wherein said control unit is a processor.

27. The system of claim 24 wherein the time delays between the transmissions by said control unit to said computer increase until an upper limit is reached.

28. The system of claim 24 wherein the time delays between the transmissions by said control unit to said computer vary in a pre-determined manner.

29. The system of claim 24 wherein the time delays between the transmissions by said control unit to said computer vary in a random manner.

30. The system of claim 24 wherein each one of said plurality of small portions of said long secret vary in length in a pre-determined manner.

31. The system of claim 24 wherein each one of said plurality of small portions of said long secret vary in length in a random manner.

32. The system of claim 24 wherein said long secret is created in whole or in part utilizing an algorithm.

33. The system of claim 24 wherein said long secret is periodically changed.

34. The system of claim 24 wherein said server acts as a proxy server.

35. The system of claim 24 wherein said authentication device contains at least one internal clock.
